(19) United States
(12) Patent Application Publication
(10) Pub. No.: US 2022/0240352 A1
(43) Pub. Date: Jul. 28, 2022

(54) ELECTRICALLY HEATING SUPPORT AND EXHAUST GAS PURIFYING DEVICE

(71) Applicant: NGK Insulators, Ltd., Nagoya-City (JP)

(72) Inventors: Yukiharu MORITA, Nagoya-City (JP); Naoya TAKASE, Konan-City (JP); Yoshiyuki KASAI, Kasugai-City (JP); Tatsushi ICHIKAWA, Toyota-City (JP)

(73) Assignee: NGK Insulators, Ltd., Nagoya-City (JP)

(21) Appl. No.: 17/659,342

(22) Filed: Apr. 15, 2022

Related U.S. Application Data
(63) Continuation of application No. PCT/JP2020/035130, filed on Sep. 16, 2020.

(30) Foreign Application Priority Data
Jan. 7, 2020 (JP) 2020-000981

(51) Int. Cl. H05B 3/03; H05B 3/14; H05B 3/44

(52) U.S. Cl. CPC H05B 3/03; H05B 3/141; H05B 3/148; H05B 2203/02; H05B 2203/024; H05B 2203/019; H05B 3/44

(57) ABSTRACT

An electrically heating support includes: a pillar shaped honeycomb structure including: an outer peripheral wall; and a partition wall disposed on an inner side of the outer peripheral wall, the partition wall defining a plurality of cells, each of the plurality of cells extending from one end face to the other end face to form a flow path; and a pair of electrode layers disposed so as to face each other across a central axis of the honeycomb structure, each of the electrode layers being disposed on a surface of the outer peripheral wall of the honeycomb structure; and a metal terminal provided on each of the electrode layers. The honeycomb structure includes a ceramic having a PTC property, and the electrode layers include a ceramic having an NTC property.

### FIELD OF THE INVENTION

The present invention relates to an electrically heating support and an exhaust gas purifying device.

### BACKGROUND OF THE INVENTION

Ceramic supports having an NTC property (i.e., a property in which electrical resistance decreases as a temperature increases), which are composed of SiC, are used as supports for electrically heating catalysts (EHCs).

Here, Patent Literature 1 discloses that a support exhibiting an NTC property tends to have a bias of a temperature distribution due to local heat generation caused by concentrated current flowing in a portion where a distance between electrodes is shorter, during heating by current conduction. Then, in order to improve the bias of the temperature distribution, it discloses the use of a support having a PTC property (a property in which electric resistance increases as a temperature increases).

Further, Patent Literature 1 discloses an electrically heating catalyst including: the support described above; a pair of electrodes arranged to face each other on an outer peripheral wall of the support; and a voltage applying portion for applying a voltage to the electrodes.

### CITATION LIST

### Patent Literature

[Patent Literature 1] Japanese Patent Application Publication No. 2019-012682 A

### SUMMARY OF THE INVENTION

The present inventors have studied the combination of the support having the PTC property and the electrode layer, and found that there is a problem that depending on the nature of the resistance of the electrode layer, the resistance of the entire EHC including the support and the electrode layer increases as the temperature of the support increases, so that it difficult to apply a constant power to the EHC over time.

The present invention has been made in view of the above problems. An object of the present invention is to provide an electrically heating support and an exhaust gas purifying device, which can control the resistance between the support and the electrode layer to control the balance of resistance over the entire EHC, and which can easily apply a constant power over time.

The above problems are solved by the following inventions. The present inventions are specified as follows:

(1)

An electrically heating support, comprising:
a pillar shaped honeycomb structure comprising: an outer peripheral wall; and a partition wall disposed on an inner side of the outer peripheral wall, the partition wall defining a plurality of cells, each of the plurality of cells extending from one end face to the other end face to form a flow path; and

a pair of electrode layers disposed so as to face each other across a central axis of the honeycomb structure, each of the electrode layers being disposed on a surface of the outer peripheral wall of the honeycomb structure; and

a metal terminal provided on each of the electrode layers,

wherein the honeycomb structure comprises a ceramic having a PTC property, and the electrode layers comprise a ceramic having an NTC property.

(2)

An exhaust gas purifying device, comprising:

the electrically heating support according to (1); and

a can body for holding the electrically heating support.

According to the present invention, it is possible to provide an electrically heating support and an exhaust gas purifying device, which can control the resistance between the support and the electrode layer to control the balance of resistance over the entire EHC, and which can easily apply a constant power over time.

### BRIEF DESCRIPTION OF THE DRAWINGS

FIG. 1 is a schematic external view of a pillar shaped honeycomb structure of an electrically heating support according to an embodiment of the present invention; and

FIG. 2 is a schematic cross-sectional view of electrode layers provided on a pillar shaped honeycomb structure of an electrically heating support according to an embodiment of the present invention and electrode terminals provided on the electrode layers, which is perpendicular to an extending direction of cells.

### DETAILED DESCRIPTION OF THE INVENTION

Hereinafter, embodiments of an electrically heating support and an exhaust gas purifying device according to the present invention will be described with reference to the drawings. However, the present invention is not limited to the embodiments, and various changes, modifications, and improvements may be added without departing from the scope of the present invention, based on knowledge of one of ordinary skill in the art.

### <Electrically Heating Support>

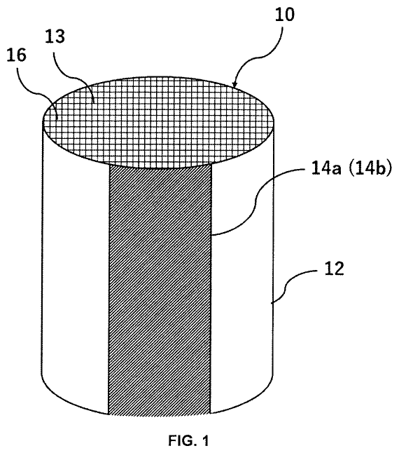

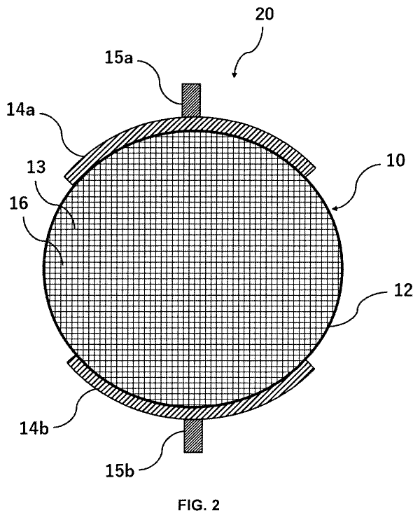

FIG. 1 is a schematic external view of a pillar shaped honeycomb structure 10 of an electrically heating support 20 according to an embodiment of the present invention. FIG. 2 is a schematic cross-sectional view of electrode layers 14a, 14b provided on the pillar shaped honeycomb structure 10 of the electrically heating support 20 according to an embodiment of the present invention and electrode terminals 15a, 15b provided on the electrode layers 14a, 14b, which is perpendicular to an extending direction of cells.

### (1. Pillar Shaped Honeycomb Structure)

The pillar shaped honeycomb structure 10 includes: an outer peripheral wall 12; and a partition wall 13 which is disposed on an inner side of the outer peripheral wall 12 and defines a plurality of cells 16 extending from one end face to other end face to form flow paths.

The pillar shaped honeycomb structure 10 is composed of a ceramic having a PTC property. The ceramic having the PTC property that is composed of the pillar shaped honeycomb structure 10 includes borosilicate salts containing alkaline atoms. Examples of the alkaline atoms include Na, Mg, K, Ca Li, Be, Sr, Cs, and Ba. The borosilicate may contain one or more alkali metal atoms, one or more alkaline earth metal atoms, or a combination of thereof. More preferably, the alkaline atoms are Na, Mg, K, or Ca.

As will be described in detail later, the pillar shaped honeycomb structure 10 may have a matrix composed of the borosilicate containing the alkaline atom as described above, and a domain composed of a conductive filler. The matrix is a region that will form a base material of the pillar shaped honeycomb structure 10. It should be noted that the matrix may be amorphous or crystalline. According to such a configuration, the matrix that will form the base material is a region that will dominate electrical resistance when the EHC is heated by current conduction.

The matrix has lower temperature-dependency on electrical resistivity than that of SiC materials, and the electrical resistivity shows the PTC property.

The borosilicate may have a total content of alkaline atoms of 10% by mass or less. More preferably, the total content of the alkaline atoms may be 5% by mass or less, or 2% by mass or less. Such a configuration can easily reduce the electric resistance of the matrix, so that the electrical resistivity of the matrix will further show the PTC property. Further, it is possible to suppress the formation of an insulating glass film due to segregation of the alkaline atoms on the surface side of the pillar shaped honeycomb structure 10 during firing in an oxidizing atmosphere. The lower limit of the total content of alkaline atoms in the borosilicate is not particularly limited, but it may be 0.01% by mass or more, or 0.2% by mass or more. The alkaline atoms may be intentionally added to suppress the oxidation of the conductive filler. Further, the alkaline atoms will complicate the production steps in order to completely remove them because they are elements that are relatively easily contaminated from the raw materials of the pillar shaped honeycomb structure 10. Therefore, the alkaline atoms are typically contained within the above range. It is also possible to reduce the alkaline atoms by using boric acid in the pillar shaped honeycomb structure 10 without using the borosilicate glass containing the alkaline atoms as a raw material. As used herein, the “total content of alkaline atoms” means, when the borosilicate contains one kind of alkaline atom, the % by mass of the one kind of alkaline atom. Also, it means, when the borosilicate contains a plurality of alkaline atoms, the total (% by mass) of the contents (% by mass) of the plurality of alkaline atoms.

The content of each of the B (boron) atom, Si (silicon) atom, and O (oxygen) atom making up the borosilicate is preferably in the following range, for example. The content of B atoms in the borosilicate is 0.1% by mass or more and 5% by mass or less. The content of Si atoms in the borosilicate is 5% by mass or more and 40% by mass or less. The content of O atoms in the borosilicate is 40% by mass or more and 85% by mass or less. According to such a configuration, it is possible to easily exhibit the PTC property in the pillar shaped honeycomb structure 10.

Examples of the borosilicate that can be used herein include aluminoborosilicate, and the like. Such a configuration can provide the pillar shaped honeycomb structure 10 which has lower temperature-dependency on the electrical resistivity, exhibits the PTC property for the electrical resistivity, or has suppressed temperature-dependency on the electrical resistivity. The content of Al atoms in the aluminoborosilicate may be, for example, 0.5% by mass or more and 10% by mass or less.

In addition to the atoms in the borosilicate as described above, examples of the atoms contained in the borosilicate making up the matrix include Fe and C. The contents of the alkaline atoms, Si, O, and Al, among the atoms described above, can be measured using an electron probe microanalyzer (EPMA) analyzer. The content of B, among the atoms as described above, can be measured using an inductively coupled plasma (ICP) analyzer. According to the ICP analysis, the content of B in the entire pillar shaped honeycomb structure 10 is measured, so that the obtained measurement result is converted into the content of B in the borosilicate.

When the pillar shaped honeycomb structure 10 has the matrix and the conductive filler, the electrical resistivity of the entire pillar shaped honeycomb structure 10 is determined by adding the electrical resistivity of the matrix and the electrical resistivity of the conductive filler together. Therefore, adjusting the conductivity of the conductive filler and the content of the conductive filler can allow the electrical resistivity of the pillar shaped honeycomb structure 10 to be controlled. The electrical resistivity of the conductive filler may exhibit either the PTC property or the NTC property, and there may be no temperature-dependency on the electrical resistivity.

The conductive filler may contain Si atoms. Such a configuration can improve the shape stability of the pillar shaped honeycomb structure 10. Examples of the conductive filler containing Si atoms include Si particles, Fe—Si-based particles, Si—W-based particles, Si—C-based particles, Si—Mo-based particles, Si—Ti-based particles, and the like. These can be used alone or in combination of two or more.

The Si particles may be Si particles doped with a dopant(s). The dopant includes boron (B), aluminum (Al), gallium (Ga), indium (In), nitrogen (N), phosphorus (P), arsenic (As), antimony (Sb), bismuth (Bi) and the like. A concentration of the dopant contained as a dopant in the silicon particles may be in the range of 1×10¹⁶ to 5×10²⁰/cm³. Here, in general, as the concentration of the dopant in the Si particles increases, the volume resistivity of the honeycomb structure 10 decreases, and as the concentration of the dopant in the Si particles decreases, the volume resistivity of the honeycomb structure 10 increases. The amount of the dopant in the silicon particles contained in the honeycomb structure 10 may preferably be 5×10¹⁶ to 5×10²⁰/cm³, and more preferably 5×10¹⁷ to 5×10²⁰/cm³.

Multiple types of elements may be contained, because if the dopants in the Si particles contained in the honeycomb structure 10 are elements belonging to the same group, the electrical conductivity can be developed without being affected by counter-doping. Further, it is more preferable to contain one or two dopants selected from the group consisting of B and Al. It is also preferable to contain one or two dopants selected from the group consisting of N and P.

When the pillar shaped honeycomb structure 10 has the matrix and the conductive filler, the pillar shaped honeycomb structure 10 may have a total of 50 vol % or more of the matrix and the conductive filler.

A rate of increase in electrical resistance of the pillar shaped honeycomb structure 10 is preferably 1×10⁻⁸ to 5×10⁻⁴ Ω·m/K. The rate of increase in electrical resistance of the pillar shaped honeycomb structure 10 of 1×10⁻⁸ Ω·m/K or more can lead to easy suppression of a temperature distribution during heating by electrical conduction. The rate of increase in electrical resistance of the pillar shaped honeycomb structure 10 is 5×10⁻⁴ Ω·m/K or less can lead to a decreased change in resistance during heating by electrical conduction. The rate of increase in electrical resistance of the pillar shaped honeycomb structure 10 is more preferably 5×10⁻⁸ to 1×10⁻⁴ Ω·m/K, and more preferably 1×10⁻⁷ to 1×10⁻⁴ Ω·m/K. The rate of increase in electrical resistivity of the pillar shaped honeycomb structure 10 can be determined by, first, measuring the electrical resistivities at two points at 50° C. and 400° C. by the four-terminal method, subtracting the electrical resistivity at 50° C. from the electrical resistivity at 400° C. to derive a value, and dividing the value by a temperature difference 350° C. between 400° C. and 50° C. to calculate the rate of increase in electrical resistivity.

An outer shape of the pillar shaped honeycomb structure 10 is not particularly limited as long as it is pillar shaped. It may be, for example, a shape such as a pillar shape with circular end faces (cylindrical shape), a pillar shape with oval end faces, and a pillar shape with polygonal (quadrangular, pentagonal, hexagonal, heptagonal, octagonal, etc.) end faces. The pillar shaped honeycomb structure 10 preferably has a size such that an area of the end faces is from 2000 to 20000 mm², and more preferably from 5000 to 15000 mm², for the purpose of improving heat resistance (suppressing cracks generated in a circumferential direction of the outer peripheral wall).

The pillar shaped honeycomb structure 10 has electrical conductivity. Electrical resistivity is not particularly limited as long as the pillar shaped honeycomb structure 10 can generate heat by Joule heat upon electrical conduction. The electrical resistivity is preferably from 0.0001 to 2 (cm, more preferably from 0.0005 to 1 Ω·cm, and more preferably from 0.001 to 0.5 Ω·cm. As used herein, the electrical resistivity of the pillar shaped honeycomb structure 10 is a value measured at 25° C. by a four-terminal method.

A cell shape in a cross section perpendicular to an extending direction of the cells 16 is not limited, but it is preferably a quadrangle, a hexagon, an octagon, or a combination thereof. Among these, the quadrangle and the hexagon are preferred. Such a cell shape can lead to a decreased pressure loss upon flowing of an exhaust gas through the pillar shaped honeycomb structure 10, resulting in improvement of purification performance of the catalyst. The quadrangle is particularly preferable in terms of easily achieving both structural strength and heating uniformity.

The partition wall 13 that defines the cells 16 preferably has a thickness of from 0.1 to 0.3 mm, and more preferably from 0.1 to 0.2 mm. The thickness of the partition wall 13 of 0.1 mm or more can suppress a decrease in the strength of the pillar shaped honeycomb structure 10. The thickness of the partition wall 13 of 0.3 mm or less can suppress an increase in pressure loss upon flowing of an exhaust gas, when the pillar shaped honeycomb structure 10 is used as a catalyst support and a catalyst is supported thereon. As used herein, the thickness of the partition wall 13 is defined as a length of a portion passing through the partition wall 13, among line segments connecting centers of gravity of the adjacent cells 16 in a cross section perpendicular to the extending direction of the cells 16.

The pillar shaped honeycomb structure 10 preferably has a cell density of from 40 to 150 cells/cm², and more preferably from 70 to 100 cells/cm², in a cross section perpendicular to a flow path direction of the cells 16. The cell density in such a range can increase the purification performance of the catalyst while reducing the pressure loss upon flowing of an exhaust gas. The cell density of 40 cells/cm² or more can ensure a sufficient catalyst supporting area. The cell density of 150 cells/cm² or less can prevent a pressure loss upon flowing of an exhaust gas from being excessively increased when the pillar shaped honeycomb structure 10 is used as a catalyst support and a catalyst is supported thereon. The cell density is a value obtained by dividing the number of cells by an area of one end face of the pillar shaped honeycomb structure 10 excluding the outer peripheral wall 12.

The provision of the outer peripheral wall 12 of the pillar shaped honeycomb structure 10 is useful in terms of ensuring the structural strength of the pillar shaped honeycomb structure 10 and preventing a fluid flowing through the cells 16 from leaking from the outer peripheral wall 12. More particularly, the thickness of the outer peripheral wall 12 is preferably 0.1 mm or more, and more preferably 0.15 mm or more, and even more preferably 0.2 mm or more. However, if the outer peripheral wall 12 is too thick, the strength becomes too high, so that a strength balance between the outer peripheral wall 12 and the partition wall 13 is lost to reduce thermal shock resistance. Therefore, the thickness of the outer peripheral wall 12 is preferably 1.0 mm or less, and more preferably 0.7 mm or less, and still more preferably 0.5 mm or less. As used herein, the thickness of the outer peripheral wall 12 is defined as a thickness of the outer peripheral wall 12 in a direction of a normal line to a tangential line at a measurement point when observing a portion of the outer peripheral wall 12 to be subjected to thickness measurement in a cross section perpendicular to a cell extending direction.

The partition wall 13 preferably has a porosity of from 0.1 to 20%. The porosity of the partition wall 13 of 0.1% or more allows the catalyst to be easily supported. The porosity of the partition wall 13 of 20% or less can reduce a risk of damage during canning. The porosity of the partition wall 13 is more preferably from 1 to 15%, and even more preferably from 5 to 15%. The porosity is a value measured by a mercury porosimeter.

### (2. Electrode Layer)

The pillar shaped honeycomb structure 10 is provided with a pair of electrode layers 14a, 14b on the surface of the outer peripheral wall 12 so as to face each other across the central axis of the pillar shaped honeycomb structure 10. The electrode layers 14a, 14b are made of a ceramic having an NTC property.

In the electrically heating support 20 according to the embodiment of the present invention, the pillar shaped honeycomb structure 10 is made of a ceramic having a PTC property (property in which the electric resistance increases as the temperature increases), and the electrode layers 14a, 14b are made of a ceramic having an NTC property (property in which the electrical resistance decreases as the temperature increases), so that the resistance of the pillar shaped honeycomb structure 10 and the electrode layers 14a, 14b can be controlled to control the balance of the resistance of the entire EHC, thereby providing an electrically heating support in which a constant electric power can be easily applied to the EHC over time.

The thermal conductivity of the electrode layers 14a, 14b is preferably higher than that of the pillar shaped honeycomb structure 10. In general, when the pair of electrode layers are provided on the surface of the outer peripheral wall of the pillar shaped honeycomb structure so as to face each other across the central axis of the pillar shaped honeycomb structure, the current flowing from the outside to the electrode layers tends to flow unevenly toward the central portion of the pillar shaped honeycomb structure, which has the lowest resistance. On the other hand, as shown in the embodiment of the present invention, when the thermal conductivity of the electrode layers 14a, 14b is higher than that of the pillar shaped honeycomb structure 10, the electrode layers 14a, 14b on the surface of the outer peripheral wall 12 of the pillar shaped honeycomb structure 10 tend to warm, resulting in lower resistance of the electrode layers 14a, 14b. In this case, the current flowing from the outside to the electrode layers 14a, 14b flows through the portion having lower resistance, but the resistance of the electrode layers 14a, 14b is lower, so that the current will flow dispersedly toward an outer side portion of the pillar shaped honeycomb structure 10 without being biased to the central portion of the pillar shaped honeycomb structure 10. As a result, it is expected that the entire pillar shaped honeycomb structure 10 tends to be uniformly heated.

The rate of increase in electrical resistance of the electrode layers 14a, 14b is preferably −1×10⁻⁴ to −5×10⁻⁹ Ω·m/K. The rate of increase in electrical resistance of the electrode layers 14a, 14b of −1×10⁻⁴ Ω·m/K or more can lead to reduced resistance during heating by electrical conduction. The rate of increase in electrical resistance of the electrode layers 14a, 14b of −5×10⁻⁹ Ω·m/K or less can lead to a decreased change in resistance during heating by electrical conduction. The rate of increase in electrical resistance of the electrode layers 14a, 14b is more preferably −5×10⁻⁵ to −2×10⁻⁸ Ω·m/K, and even more preferably −1×10⁻⁵ to −1×10⁻⁷ Ω·m/K. The rate of increase in electrical resistivity of the electrode layers 14a, 14b can be determined by measuring the electrical resistivities at two points at 50° C. and 400° C. by the four-terminal method, subtracting the electrical resistivity at 50° C. from the electrical resistivity at 400° C. to derive a value, and dividing the value by a temperature difference 350° C. between 400° C. and 50° C. to calculate the rate of increase in electrical resistivity.

The electrode layers 14a, 14b may be mainly based on silicon, silicon carbide, or a composite of silicon and silicon carbide. As used herein, “mainly based on” means that the content in the components making up the electrode layers is more than 50% by mass.

The electrical resistivity of the electrode layers 14a, 14b is not particularly limited, but it may preferably be 1×10⁻⁵ to 5×10⁻¹ Ω·m. The electric resistivity of the electrode layers 14a, 14b of 5×10⁻¹ Ω·m or less can lead to reduced resistance during heating by electrical conduction. The electrical resistivity of the electrode layers 14a, 14b is more preferably 1×10⁻⁴ to 2×10⁻¹ Ω·m, and even more preferably 5×10⁻³ to 1×10⁻¹ Ω·m. As used herein, the electrical resistivity of the electrode layers 14a, 14b is a value measured at 25° C. by the four-terminal method.

The electrode layers 14a, 14b may be formed in a non-limiting region. In terms of enhancing uniform heat generation of the pillar shaped honeycomb structure 10, each of the electrode layers 14a, 14b is preferably provided on the outer surface of the outer peripheral wall 12 so as to extend in the form of strip in the circumferential direction and in the extending direction of the cells 16. More particularly, it is desirable that each of the electrode layers 14a, 14b extends over a length of 80% or more, and preferably 90% or more, and more preferably the full length, between both end faces of the pillar shaped honeycomb structure 10, from the viewpoint that a current easily spreads in an axial direction of each of the electrode layers 14a, 14b.

Each of the electrode layers 14a, 14b preferably has a thickness of from 0.01 to 5 mm, and more preferably from 0.01 to 3 mm. Such a range can allow uniform heat generation to be enhanced. The thickness of each of the electrode layers 14a, 14b of 0.01 mm or more can lead to appropriate control of electric resistance, resulting in more uniform heat generation. The thickness of 5 mm or less can reduce a risk of breakage during canning. The thickness of each of the electrode layers 14a, 14b is defined as a thickness in a direction of a normal line to a tangential line at a measurement point on an outer surface of each of the electrode layers 14a, 14b when observing the point of each electrode layer to be subjected to thickness measurement in a cross section perpendicular to the cell extending direction.

### (3. Electrode Terminal)

Each of the electrode terminals 15a, 15b may be formed in a pillar shape. The electrode terminals 15a, 15b are arranged on the electrode layers 14a, 14b, respectively, and are electrically connected. Accordingly, as a voltage is applied to the metal terminals 15a, 15b, then the electricity is conducted through the metal terminals 15a, 15b to allow the pillar shaped honeycomb structure 10 to generate heat by Joule heat. Therefore, the pillar shaped honeycomb structure 10 can also be suitably used as a heater. The applied voltage is preferably from 12 to 900 V, and more preferably from 48 to 600 V, although the applied voltage can be changed as needed.

The electrode terminals 15a, 15b may be made of a ceramic. When the electrode terminals 15a, 15b are made of the ceramic, a difference in thermal expansion coefficient between each of the electrode terminals 15a, 15b and each of the electrode layers 14a, 14b is decreased, because the electrode layers 14a, 14b are made of the ceramic having the NTC property. Therefore, it is possible to suppress cracking or peeling of the electrode terminals 15a, 15b and the electrode layers 14a, 14b due to thermal expansion.

Non-limiting examples of the ceramic making up the electrode terminals 15a, 15b include silicon carbide (SiC), and metal compounds such as metal silicides such as tantalum silicide (TaSi₂) and chromium silicide (CrSi₂), and further include a composite material (cermet) containing one or more metals. Specific examples of the cermet include a composite material of silicon and silicon carbide, a composite material of metal silicide such as tantalum silicide and chromium silicide, metal silicon, and silicon carbide, and further a composite material obtained by adding to one or more metals listed above, one or more insulating ceramics such as alumina, mullite, zirconia, cordierite, silicon nitride, and aluminum nitride, in terms of decreased thermal expansion. The material of each electrode terminal may be the same as that of each electrode layer.

When the electrode terminals 15a, 15b are ceramic terminals, metal terminals may be joined to its tips, respectively. The ceramic terminals and the metal terminals can be joined by caulking, welding, a conductive adhesive or the like. The materials of the metal terminals that can be used herein includes conductive metals such as iron alloys and nickel alloys.

When the electrode terminals 15a, 15b are ceramic terminals, each outer shape of the terminals is preferably pillar shaped. Each outer shape of the electrode terminals 15a, 15b is not particularly limited as long as it is pillar shaped. For example, the electrode terminal 15a, 15b can have a shape such as a pillar shape with circular end faces (cylindrical shape), a pillar shape with oval end faces and a pillar shape with polygonal (quadrangular, pentagonal, hexagonal, heptagonal, octagonal, etc.) end faces. The size of each of the electrode terminals 15a, 15b is not limited, and the electrode terminals 15a, 15b may be formed in a pillar shape in which an area of the end faces is, for example, from 10 to 350 mm², and the height is from 10 to 100 mm.

By supporting the catalyst on the electrically heating support 20, the electrically heating support 20 can be used as a catalyst. For example, a fluid such as an exhaust gas from a motor vehicle can flow through the flow paths of the plurality of cells 16. Examples of the catalyst include noble metal catalysts or catalysts other than them. Illustrative examples of the noble metal catalysts include a three-way catalyst and an oxidation catalyst obtained by supporting a noble metal such as platinum (Pt), palladium (Pd) and rhodium (Rh) on surfaces of pores of alumina and containing a co-catalyst such as ceria and zirconia, or a NOx storage reduction catalyst (LNT catalyst) containing an alkaline earth metal and platinum as storage components for nitrogen oxides (NO.). Illustrative examples of a catalyst that does not use the noble metal include a NOx selective reduction catalyst (SCR catalyst) containing a copper-substituted or iron-substituted zeolite, and the like. Further, two or more catalysts selected from the group consisting of those catalysts may be used. A method for supporting the catalyst is not particularly limited, and it can be carried out according to a conventional method for supporting the catalyst on the honeycomb structure.

### <Method for Producing Electrically Heating Support)

A method for producing the electrically heating support according to the present invention will be illustratively described. In an embodiment, the method for producing the electrically heating support according to the present invention includes: a step A1 of obtaining an unfired pillar shaped honeycomb structure with an electrode terminal forming paste; and a step A2 of firing the unfired pillar shaped honeycomb structure with the electrode terminal forming paste to form a pillar shaped honeycomb structure with electrode terminals. Further, as another embodiment, an electrode layer forming paste and the electrode terminal forming paste may be calcined and then attached to the honeycomb structure.

The step A1 is to prepare a pillar shaped honeycomb formed body that is a precursor of the pillar shaped honeycomb structure, and apply an electrode layer forming paste to a side surface of the pillar shaped honeycomb formed body to obtain the unfired pillar shaped honeycomb structure with the electrode layer forming paste, and then providing the electrode terminal forming paste onto the electrode layer forming paste to form the unfired pillar shaped honeycomb structure with the electrode terminal forming paste.

To prepare the pillar shaped honeycomb formed body, first, boric acid, a conductive filler containing Si atoms, and kaolin are mixed. Alternatively, a borosilicate containing alkaline atoms, a conductive filler containing Si atoms, and kaolin may be mixed. The borosilicate may have a fibrous or particulate shape, and is preferably fibrous because it improves the extrudability of the mixture. In the mixture, a mass ratio of boric acid is preferably 4 or more and 8 or less, in order to easily provide the pillar shaped honeycomb structure 10 having lower temperature-dependency on electrical resistivity. The content of boron contained in the borosilicate can be increased by rising a firing temperature as described later. As an amount of boron doped in the silicate is higher, the electrical resistance of the pillar shaped honeycomb structure 10 can be lower.

Subsequently, to the mixture are added a binder and water. Examples of the binder include methyl cellulose, hydroxypropylmethyl cellulose, hydroxypropoxyl cellulose, hydroxyethyl cellulose, carboxymethyl cellulose, polyvinyl alcohol and the like. Further, the content of the binder may be, for example, about 2% by mass.

The resulting forming raw materials are then kneaded to form a green body, and the green body is then extruded to prepare a pillar shaped honeycomb structure. In extrusion molding, a die having a desired overall shape, cell shape, partition wall thickness, cell density and the like can be used. Preferably, the resulting pillar shaped honeycomb structure is then dried. When the length in the central axis direction of the pillar shaped honeycomb structure is not the desired length, both the end faces of the pillar shaped honeycomb structure can be cut to the desired length. The pillar shaped honeycomb structure after drying is referred to as a pillar shaped honeycomb dried body.

The electrode layer forming paste for forming electrode layers is then prepared. The electrode layer forming paste can be prepared by mixing silicon carbide and silicon at a mass ratio of 20:80 and mixing them with a binder and water. The silicon carbide powder contained in the electrode layer forming raw material may use a powder having an average particle diameter of 3 to 50 μm. The average particle diameter of the silicon carbide powder of less than 3 μm tends to increase the number of interfaces and increase the resistance. Further, the average particle diameter of the silicon carbide powder of more than 50 μm tends to decrease the strength and deteriorate the thermal impact resistance.

The resulting electrode layer forming paste is then applied to the side surface of the pillar shaped honeycomb formed body (typically, the pillar shaped honeycomb dried body) to obtain an unfired pillar shaped honeycomb structure with an electrode layer forming paste. The method for applying the electrode layer forming paste to the pillar shaped honeycomb formed body can be performed according to a known method for producing a pillar shaped honeycomb structure.

As a variation of the method for producing the pillar shaped honeycomb structure, in the step A1, the pillar shaped honeycomb formed body may be temporarily fired before applying the electrode layer forming paste. That is, in this variation, the pillar shaped honeycomb formed body is fired to produce a pillar shaped honeycomb fired body, and the electrode fired paste is applied to the pillar shaped honeycomb fired body.

The electrode terminal forming paste for forming the electrode terminals is then prepared. The electrode terminal forming paste can be prepared by appropriately adding various additives to the ceramic powder blended according to the required characteristics for the electrode terminals, and kneading them. Subsequently, the prepared electrode terminal forming paste is provided in the form of the pillar shape on the surface of the electrode layers on the pillar shaped honeycomb structure.

In the step A2, the unfired pillar shaped honeycomb structure with the electrode terminal forming paste is fired to obtain the pillar shaped honeycomb structure with the electrode terminals. The firing conditions can be under an inert gas atmosphere or an air atmosphere, and at or below atmospheric pressure and at a firing temperature of 1150 to 1350° C., and for a firing time of 0.1 to 50 hours. The firing atmosphere may be, for example, an inert gas atmosphere, and the firing pressure may be normal pressure. In order to reduce the electrical resistance of the pillar shaped honeycomb structure 10, it is preferable to reduce the residual oxygen in terms of preventing oxidation, and it is also preferable to create a high vacuum of 1.0×10⁻⁴ Pa or more in the atmosphere during firing, and then purge it with the inert gas and perform the firing. Examples of the inert gas atmosphere include an N₂ gas atmosphere, a helium gas atmosphere, and an argon gas atmosphere. Prior to the firing, the unfired pillar shaped honeycomb structure with the electrode terminal forming paste may be dried. Further, prior to the firing, degreasing may be performed in order to remove the binder and the like. The electrically heating support in which the electrode terminals are electrically connected to the electrode layers can be thus obtained.

### <Exhaust Gas Purifying Device>

Each of the electrically heating supports according to the above embodiments of the present invention can be used for an exhaust gas purifying device. The exhaust gas purifying device includes the electrically heating support and a can body for holding the electrically heating support. In the exhaust gas purifying device, the electrically heating support can be installed in an exhaust gas flow path for allowing an exhaust gas from an engine to flow. As the can body, a metal tubular member or the like for accommodating the electrically heating support can be used.

### DESCRIPTION OF REFERENCE NUMERALS

10 pillar shaped honeycomb structure
12 outer peripheral wall
13 partition wall
14a, 14b electrode layer
15a, 15b electrode terminal
16 cell
20 electrically heating support

1. An electrically heating support, comprising:
a pillar shaped honeycomb structure comprising: an outer peripheral wall; and a partition wall disposed on an inner side of the outer peripheral wall, the partition wall defining a plurality of cells, each of the plurality of cells extending from one end face to the other end face to form a flow path; and
a pair of electrode layers disposed so as to face each other across a central axis of the honeycomb structure, each of the electrode layers being disposed on a surface of the outer peripheral wall of the honeycomb structure; and
a metal terminal provided on each of the electrode layers,
wherein the honeycomb structure comprises a ceramic having a PTC property, and the electrode layers comprise a ceramic having an NTC property.

2. The electrically heating support according to claim 1, wherein each of the electrode layers has higher thermal conductivity than that of the honeycomb structure.

3. The electrically heating support according to claim 1, wherein the electrode layers are mainly based on silicon, silicon carbide, or a composite of silicon and silicon carbide.

4. The electrically heating support according to claim 1, wherein the electrode terminals are made of a ceramic.

5. The electrically heating support according to claim 1, wherein an outer shape of each of the electrode terminals is pillar-shaped.

6. The electrically heating support according to claim 1, wherein the honeycomb structure has: a matrix composed of a borosilicate containing alkaline atoms; and a domain composed of a conductive filler.

7. The electrically heating support according to claim 1, wherein the honeycomb structure has a rate of increase in electrical resistance of 1×10⁻⁸ to 5×10⁻⁴ Ω·m/K.

8. The electrically heating support according to claim 1, wherein each of the electrode layers has a rate of increase in electrical resistance of −1×10⁻³ to −5×10⁻⁹ Ω·m/K.

9. An exhaust gas purifying device, comprising:
the electrically heating support according to claim 1; and
a can body for holding the electrically heating support.
